(19) United States
(12) Patent Application Publication
(10) Pub. No.: US 2025/0245069 A1
(43) Pub. Date: Jul. 31, 2025

(54) SYSTEMS AND METHODS FOR THIRD-PARTY TRUSTED ACCESS IN A COMPUTING CLOUD PLATFORM

(71) Applicant: Dell Products L.P., Round Rock, TX (US)

(72) Inventors: Chadwick Gray, Seattle, WA (US); Kevin Stephen Labonte, Upton, MA (US); Christopher Marzullo, Manahawkin, NJ (US); Marc Albert, Sainte-Agathe-des-Monts (CA); Nicolas Le Grand, Ashburnham, MA (US)

(73) Assignee: Dell Products L.P., Round Rock, TX (US)

(21) Appl. No.: 18/422,160

(22) Filed: Jan. 25, 2024

(51) Int. Cl. G06F 9/50

(52) U.S. Cl. CPC G06F 9/5072

(57) ABSTRACT

Systems and methods for third-party trusted access are provided. According to one embodiment, an Information Handling System (IHS) includes a cloud computing platform with multiple computing resources, and computer-executable instructions to receive, from a customer, a request to grant to a computing resource management tool limited access to at least a portion of the computing resources, the computing resource management tool managed by a vendor of the computing resources, and generate an access control policy key in response to the request. The key includes one or more policies associated with how the computing resource management tool is allowed to access the portion of computing resources. The instructions also provides the key to the computing resource management tool, and accesses, by the computing resource management tool, the portion of computing resources according to the policies included in the key.

### BACKGROUND

As the value and use of information continues to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information. Because technology and information handling needs and requirements vary between different users or applications, IHSs may also vary regarding what information is handled, how the information is handled, how much information is processed, stored, or communicated, and how quickly and efficiently the information may be processed, stored, or communicated.

IHSs may be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

Many computer processing architectures have recently migrated toward cloud computing. Cloud computing generally involves the delivery of computing services over the Internet. Whereas on-premises computing solutions can refer to in-house hosted software (e.g., on local servers, private clouds, etc.) that may be supported by a third party vendor or provider, cloud computing solutions may refer to software that is hosted and maintained by the same vendor. With cloud computing, a virtualized pool of resources, from raw compute power at the infrastructure level to application functionality, is often made available to a client, on demand, by a provider. One particular advantage of cloud computing is the ability to apply abstracted versions of compute, storage, and network resources to workloads, as needed, and tap into an abundance of prebuilt services. Cloud computing may enable users to tap into additional capabilities without requiring the investment of the infrastructure, such as new hardware or software. Rather, users often pay the provider of the cloud service a subscription fee or in some cases lease the infrastructure that they use.

Multi-cloud computing refers to the use of two or more clouds from different cloud providers. This may include any mix of Infrastructure, Platform, or Software as a Service (IaaS, PaaS, or SaaS). Multi-cloud computing may be used to address specific business requirements or to avoid the limitations of a single-vendor cloud strategy. The multi-cloud environment may include cloud networks or cloud hosting environments provided by different cloud service providers. In a multi-cloud environment, the cloud networks may be managed by a multi-cloud management platform. The multi-cloud management platform includes hardware, software, firmware, or a combination thereof which provides a unified interface for deployment, provisioning, and monitoring of different cloud networks in the multi-cloud environment.

### SUMMARY

Systems and methods for third-party trusted access are provided that shows how a third-party, such as vendor or maintainer of the computing resources in a cloud computing platform, may be provided with limited access to those computing resources. According to one embodiment, an Information Handling System (IHS) includes a cloud computing platform with multiple computing resources, and computer-executable instructions to receive, from a customer, a request to grant to a computing resource management tool limited access to at least a portion of the computing resources, the computing resource management tool managed by a vendor of the computing resources, and generate an access control policy key in response to the request. The key includes one or more policies associated with how the computing resource management tool is allowed to access the portion of computing resources. The instructions also provides the key to the computing resource management tool, and accesses, by the computing resource management tool, the portion of computing resources according to the policies included in the key.

According to another embodiment, a third-party trusted access method includes the steps of receiving, from a customer, a request to grant to a computing resource management tool limited access to at least a portion of a plurality of computing resources of a cloud computing platform, and generating an access control policy key in response to the request. The key includes one or more policies associated with how the computing resource management tool is allowed to access the portion of computing resources, while the computing resource management tool is managed by a vendor of the computing resources. The third-party trusted access method further includes the steps of providing the key to the computing resource management tool, and accessing, by the computing resource management tool, the portion of computing resources according to the policies included in the key.

According to yet another embodiment, a computer program product includes a computer readable storage medium with program instructions stored thereon that, upon execution by an Information Handling System (IHS), cause the IHS to receive, from a customer, a request to grant to a computing resource management tool limited access to at least a portion of a plurality of computing resources of a cloud computing platform, and generate an access control policy key in response to the request. The computing resource management tool is managed by a vendor of the computing resources, while the key includes one or more policies associated with how the computing resource management tool is allowed to access the portion of computing resources. The program instructions further cause the IHS to provide the key to the computing resource management tool, and access, by the computing resource management tool, the portion of computing resources according to the policies included in the key.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 illustrates an example third-party trusted access system showing how a third-party, such as vendor or maintainer of the computing resources in a cloud computing platform, may be provided with limited access to those computing resources.

FIG. 2 is a block diagram of components of an IHS, of which one or more may be used to implement embodiments of the third-party trusted access system of FIG. 1.

FIG. 3 illustrates an example permissions document that may comprise a portion of the access control policy key according to one embodiment of the present disclosure.

FIG. 4 illustrates an example trust policy document that may comprise a portion of the access control policy key according to one embodiment of the present disclosure.

FIG. 5 illustrates an example third-party trusted access method that may be performed to grant cloud platform access to the computing resource management tool according to one embodiment of the present disclosure.

FIG. 6 illustrates an example computing resource correlation system showing how the computing resource management tool may be used to correlate the computing resources it manages with that of a cloud computing platform according to one embodiment of the present disclosure.

FIG. 7 illustrates an example computing resource correlation method that may be performed by the computing resource correlation system to correlate information about computing resources across different applications that manage those computing resources according to one embodiment of the present disclosure.

FIG. 8 illustrates an example GUI that may be displayed by a Software-Defined Storage (SDS) system according to one embodiment of the present disclosure.

### DETAILED DESCRIPTION

The present disclosure is described with reference to the attached figures. The figures are not drawn to scale, and they are provided merely to illustrate the disclosure. Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the present disclosure.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components.

Cloud computing generally refers to the delivery of computing resources, especially data storage and computing power, over the Internet without direct active management by the user. The term is generally used to describe data centers available to many users on a pay-for-use basis. As an increasing number of software applications are moving to the cloud and are being developed for the cloud, users are adopting a variety of cloud deployment models. These range from private clouds to public clouds, to a mix of both (i.e., hybrid clouds).

Multi-cloud computing generally refers to the use of at least two or more cloud environments at the same time. Multi-cloud computing refers to the use of two or more clouds from different cloud providers. This may include any mix of Infrastructure, Platform, or Software as a Service (laaS, PaaS, or SaaS). The term “cloud computing platform” may be used herein to refer to a configuration of distributed storage and/or computing services that may be publicly offered by providers over the Internet. Examples for such cloud platforms may include Amazon Web Services (AWS), Microsoft Azure, and Google Cloud Platform (GCP).

Computing vendors are working on delivery systems that allow customers to easily leverage various storage offerings across today's available computing environments. One goal is to provide customer options to run storage offerings with various public cloud providers and provide a platform that allows for those systems to be managed centrally while also available to the rest of the enterprise environment for workflows and data/application mobility. In particular, it would be beneficial for vendors of cloud computing resources to scale access to cloud computing platform accounts outside the purview or control of the cloud computing platform's control mechanisms.

Providing a platform for managing a vendor's resources across an enterprise customer's multi-cloud storage environment often entails the customer granting vendor access to their public cloud environments. Where security is paramount, it would be beneficial to deliver a solution to access customer environments in a manner that is secure, otherwise customers may not adopt the vendor's multi-cloud product. In order to deliver a platform that provides deployment, ongoing management, and monitoring it would be beneficial for the vendor to programmatically access the customer's environment and hold continued access rather than a short-lived access. Consider how a developer might access a cloud computing platform, such as an AWS account. The developer would be granted an AWS access key ID and a secret access key that is a long-lived credential associated with that individual user. The developer holds onto and uses the credential to authenticate, and access AWS resources. There are, however, security challenges associated with sharing AWS credentials to a third-party (e.g., computing resource vendor) to enable them to access an AWS account.

Vendors would like to support many customers using its multi-cloud platform, but cloud computing platforms typically do not advise on how a third-party (e.g., vendor) should scale trusted access for many customers, nor does it advise on how third-party solutions should access customer environments from outside the cloud computing platform's control. As more users adopt multi-cloud products, the overall solution should scale accordingly. For example, there are AWS limitations around the number of AWS accounts in an AWS organization, and other factors that can limit scaling trusted access.

Conventional attempts have included establishing a Cloud Formation Template (CFT) that specifies certain access rights that may be provided to a third-party entity, such as a vendor of the resources configured in the cloud computing platform. Such a technique still requires that the customer shares their keys with the vendor, which could potentially yield security issues. Additionally, the ability to modify the access rights is not easily accomplished without both parties approval, and may possess challenges associated with ownership of credentials and credential rotation.

Other conventional attempts have included NETAPP ONTAP, which is provided by AMAZON and provides a fully managed AWS service, or NETAPP BLUEXP in which the customer grants trust to an AWS entity or service running in AWS. Neither of these conventional tools, however, execute a deployment or monitoring outside of AWS using AWS account trust. That is, all of the aforementioned tools are maintained within the control of the cloud computing platform (e.g., AWS, Azure, GCP, etc.), and as such, yield scaling problems when large numbers of customers each with their own levels of security tolerance that are required to use the cloud computing platform to add, modify, or revoke access rights to third-parties, such as the vendor or maintainer of the computing resources configured in the cloud computing platform.

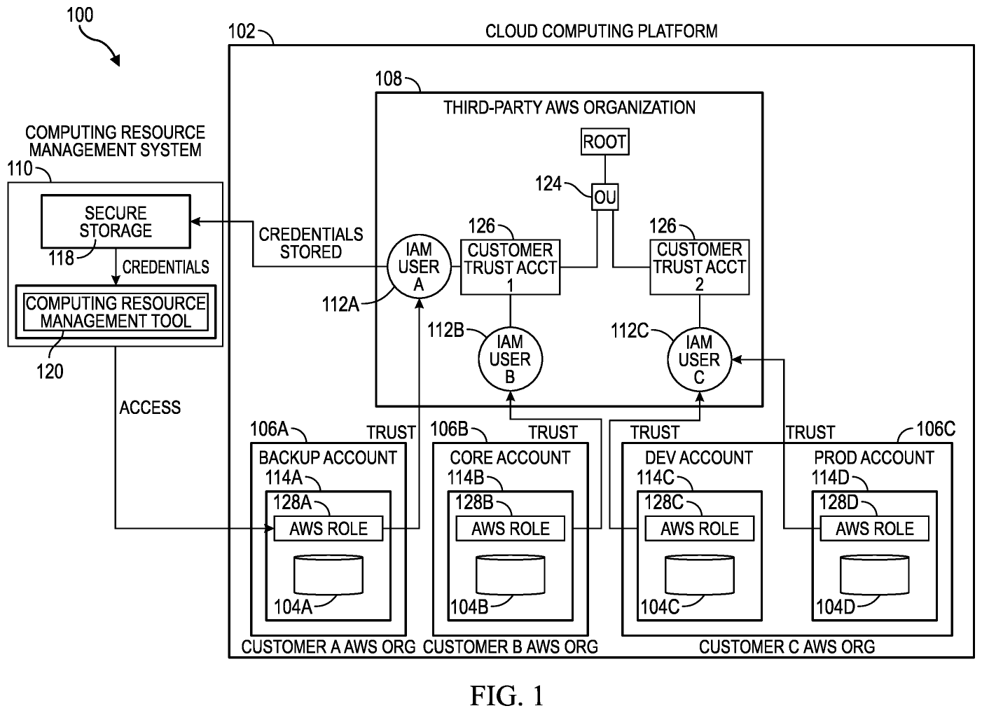

FIG. 1 illustrates an example third-party trusted access system 100 showing how a third-party, such as vendor or maintainer of the computing resources in a cloud computing platform, may be provided with limited access to those computing resources. As mentioned previously, it would be beneficial to provide limited access to the computing resources of a cloud computing platform for various reasons, such as diagnosing problems or bugs encountered by the computing resources, providing ongoing software updates to the computing resources, configuring or re-configuring the computing resources on an as-needed basis, and the like. While the present embodiments are described as being directed to an AWS cloud provider, it should be appreciated that the features of the present disclosure may use any suitable cloud provider, such as Microsoft Azure, or Google Cloud Platform (GCP).

Initially referring to FIG. 1A, the third-party trusted access system 100 includes a cloud computing platform 102 that provides or otherwise leases computing resources 104a-d (collectively 104) to its customers 106a-c (collectively 106). While the computing resources 104 as shown herein to be storage resources, it should be appreciated that the computing resources 104 may include any combination of computing resources 104, such as compute resources, and networking resources. The third-party trusted access system 100 also includes a third-party AWS organization 108 that is provided to the vendor of the computing resources 104 by the cloud computing platform 102, and a computing resource management system 110 that is maintained by the vendor of the computing resources 104.

Each customer 106 may have one or more accounts 114a-d (collectively 114). In general, each customer account 114 specifies which computing resources 104 in the cloud computing platform 102 are to be allocated to that customer account 114. For example, customers 106a-b are each provided with an access control policy key 112a-b for their associated customer account 114a-b, while customer 106c is provided with a single access control policy key 112c for each of their development customer account 114c and production customer account 114d.

According to embodiments of the present disclosure, the third-party AWS organization 108 provides a single access control policy key 112a-c (collectively 112) to each customer 106 that specifies how the computing resource management system 110 is allowed to access the computing resources 104. In one embodiment, the access control policy key 112 may comprise an AWS Identity and Access Management (IAM) policy key. The IAM policy key specifies users or other resources that can access services and resources in an AWS cloud computing platform 102, manage permissions, and analyze access to refine permissions across the cloud computing platform 102. Moreover, the IAM policy key provides specific permissions to one or more users associated with the customer 106 to which the IAM policy key has been issued.

Each customer 106 may provide a copy of the access control policy key 112 to the computing resource management system 110, which it in turn, stores the access control policy key 112 in a secure storage 118 (e.g., digital vault). The computing resource management system 110 also includes a computing resource management tool 120, such as CLOUDIQ or APEX NAVIGATOR, which manages the operation of the computing resources 104. The computing resource management tool 120 uses the access control policy key 112 to access the computing resources 104 using policies specified in each access control policy key 112.

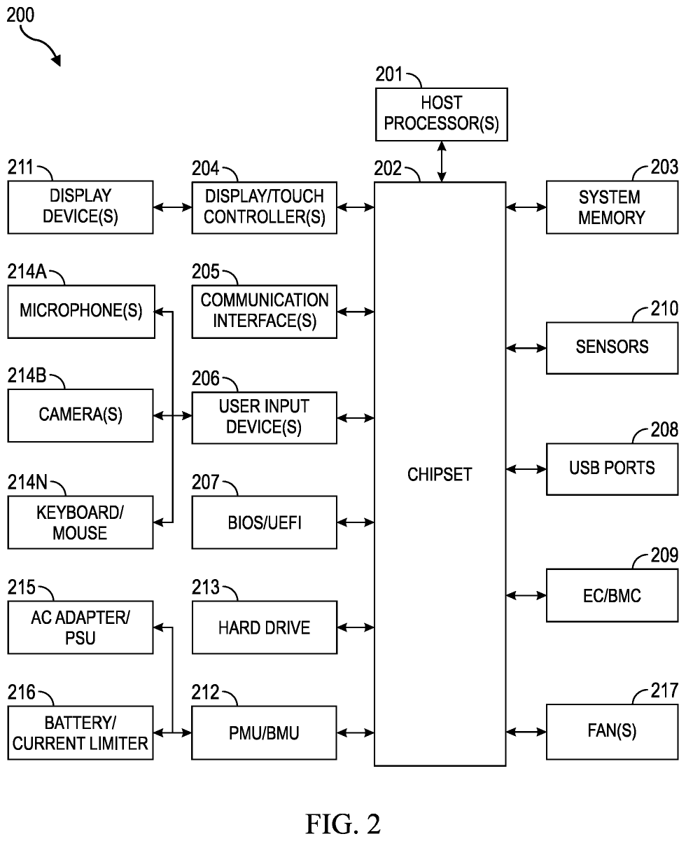

FIG. 2 is a block diagram of components of an IHS 200, of which one or more may be used to implement embodiments of the third-party trusted access system of FIG. 1. As depicted, IHS 200 includes host processor(s) 201. In various embodiments, IHS 200 may be a single-processor system, a multi-processor system including two or more processors, and/or a heterogeneous computing platform. Host processor(s) 201 may include any processor capable of executing program instructions, such as a PENTIUM processor, or any general-purpose or embedded processor implementing any of a variety of Instruction Set Architectures (ISAs), such as an x86 or a Reduced Instruction Set Computer (RISC) ISA (e.g., POWERPC, ARM, SPARC, MIPS, etc.). In some embodiments, the IHS 200 may be used to provide any suitable cloud provider resource, such as a Virtual Private Cloud (VPC), Elastic Compute Cloud (EC2), IAM resources, and/or Pivotal Container Services (PKS).

IHS 200 includes chipset 202 coupled to host processor(s) 201. Chipset 202 may provide host processor(s) 201 with access to several resources. In some cases, chipset 202 may utilize a QuickPath Interconnect (QPI) bus to communicate with host processor(s) 201.

Chipset 202 may also be coupled to communication interface(s) 205 to enable communications between IHS 200 and various wired and/or wireless networks, such as Ethernet, WiFi, BLUETOOTH (BT), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 205 may also be used to communicate with certain peripherals devices (e.g., BT speakers, microphones, headsets, etc.). Moreover, communication interface(s) 205 may be coupled to chipset 202 via a Peripheral Component Interconnect Express (PCIe) bus, or the like.

Chipset 202 may be coupled to display/touch controller(s) 204, which may include one or more Graphics Processor Units (GPUs) on a graphics bus, such as an Accelerated Graphics Port (AGP) or PCIe bus. As shown, display/touch controller(s) 204 provide video or display signals to one or more display device(s) 211.

Display device(s) 211 may include Liquid Crystal Display (LCD), Light Emitting Diode (LED), organic LED (OLED), or other thin film display technologies. Display device(s) 211 may include a plurality of pixels arranged in a matrix, configured to display visual information, such as text, two-dimensional images, video, three-dimensional images, etc. In some cases, display device(s) 211 may be provided as a single continuous display, or as two or more discrete displays.

Chipset 202 may provide host processor(s) 201 and/or display/touch controller(s) 204 with access to system memory 203. In various embodiments, system memory 203 may be implemented using any suitable memory technology, such as static RAM (SRAM), dynamic RAM (DRAM) or magnetic disks, or any nonvolatile/Flash-type memory, such as a solid-state drive (SSD) or the like.

Chipset 202 may also provide host processor(s) 201 with access to one or more Universal Serial Bus (USB) ports 208, to which one or more peripheral devices may be coupled (e.g., integrated or external webcams, microphones, speakers, etc.).

Chipset 202 may further provide host processor(s) 201 with access to one or more hard disk drives, solid-state drives, optical drives, or other removable-media drives 213.

Chipset 202 may also provide access to one or more user input devices 206, for example, using a super I/O controller or the like. Examples of user input devices 206 may include, but are not limited to, microphone(s) 214A, camera(s) 214B, and keyboard/mouse 214N. Other user input devices 206 may include a touchpad, trackpad, stylus or active pen, totem, etc.

Each user input devices 206 may include a respective controller (e.g., a touchpad may have its own touchpad controller) that interfaces with chipset 202 through a wired or wireless connection (e.g., via communication interfaces(s) 205). In some cases, chipset 202 may also provide access to one or more user output devices (e.g., video projectors, paper printers, 3D printers, loudspeakers, audio headsets, Virtual/Augmented Reality (VR/AR) devices, etc.). In certain embodiments, chipset 202 may further provide an interface for communications with hardware sensors 210.

Sensors 210 may be disposed on or within the chassis of IHS 200, or otherwise coupled to IHS 200, and may include, but are not limited to: electric, magnetic, radio, optical (e.g., camera, webcam, etc.), infrared, thermal (e.g., thermistors etc.), force, pressure, acoustic (e.g., microphone), ultrasonic, proximity, position, deformation, bending, direction, movement, velocity, rotation, gyroscope, Inertial Measurement Unit (IMU), and/or acceleration sensor(s).

The Unified Extensible Firmware Interface (UEFI) was designed as a successor to BIOS. As a result, many modern IHSs utilize UEFI in addition to or instead of a BIOS. As used herein, BIOS 207 is intended to also encompass a UEFI component.

Embedded Controller (EC) or Baseboard Management Controller (BMC) 209 is operational from the very start of each IHS power reset and handles various tasks not ordinarily handled by host processor(s) 201. Examples of these operations may include, but are not limited to: receiving and processing signals from a keyboard or touchpad, as well as other buttons and switches (e.g., power button, laptop lid switch, etc.), receiving and processing thermal measurements (e.g., performing fan control, CPU and GPU throttling, and emergency shutdown), controlling indicator LEDs (e.g., caps lock, scroll lock, number lock, battery, power, wireless LAN, sleep, etc.), managing PMU/BMU 212, alternating current (AC) adapter/Power Supply Unit (PSU) 215 and/or battery/current limiter 216, allowing remote diagnostics and remediation over network(s) 104, etc. For example, EC/BMC 209 may implement operations for interfacing with power adapter/PSU 215 in managing power for IHS 200. Such operations may be performed to determine the power status of IHS 200, such as whether IHS 200 is operating from AC adapter/PSU 215 and/or battery 216.

Firmware instructions utilized by EC/BMC 209 may also be used to provide various core operations of IHS 200, such as power management and management of certain modes of IHS 200 (e.g., turbo modes, maximum operating clock frequencies of certain components, etc.). In addition, EC/BMC 209 may implement operations for detecting certain changes to the physical configuration or posture of IHS 200. For instance, when IHS 200 is embodied as a 2-in-1 laptop/tablet form factor, EC/BMC 209 may receive inputs from a lid position or hinge angle sensor 210, and it may use those inputs to determine: whether the two sides of IHS 200 have been latched together to a closed position or a tablet position, the magnitude of a hinge or lid angle, etc. In response to these changes, the EC may enable or disable certain features of IHS 200 (e.g., front or rear facing camera, etc.).

In some cases, EC/BMC 209 may be configured to identify any number of IHS postures, including, but not limited to: laptop, stand, tablet, tent, or book. For example, when display(s) 211 of IHS 200 is open with respect to a horizontal keyboard portion, and the keyboard is facing up, EC/BMC 209 may determine IHS 200 to be in a laptop posture. When display(s) 211 of IHS 200 is open with respect to the horizontal keyboard portion, but the keyboard is facing down (e.g., its keys are against the top surface of a table), EC/BMC 209 may determine IHS 200 to be in a stand posture.

When the back of display(s) 211 is closed against the back of the keyboard portion, EC/BMC 209 may determine IHS 200 to be in a tablet posture. When IHS 200 has two display(s) 211 open side-by-side, EC/BMC 209 may determine IHS 200 to be in a book posture. When IHS 200 has two displays open to form a triangular structure sitting on a horizontal surface, such that a hinge between the displays is at the top vertex of the triangle, EC/BMC 209 may determine IHS 200 to be in a tent posture. In some implementations, EC/BMC 209 may also determine if display(s) 211 of IHS 200 are in a landscape or portrait orientation. In some cases, EC/BMC 209 may be installed as a Trusted Execution Environment (TEE) component to the motherboard of IHS 200.

Additionally, or alternatively, EC/BMC 209 may be configured to calculate hashes or signatures that uniquely identify individual components of IHS 200. In such scenarios, EC/BMC 209 may calculate a hash value based on the configuration of a hardware and/or software component coupled to IHS 200. For instance, EC/BMC 209 may calculate a hash value based on all firmware and other code or settings stored in an onboard memory of a hardware component.

Hash values may be calculated as part of a trusted process of manufacturing IHS 200 and may be maintained in secure storage as a reference signature. EC/BMC 209 may later recalculate the hash value for a component, compare it against the reference hash value to determine if any modifications have been made to the component, thus indicating that the component has been compromised. In this manner, EC/BMC 209 may validate the integrity of hardware and software components installed in IHS 200.

In various embodiments, IHS 200 may be coupled to an external power source (e.g., AC outlet or mains) through an AC adapter/PSU 215. AC adapter/PSU 215 may include an adapter portion having a central unit (e.g., a power brick, wall charger, or the like) configured to draw power from an AC outlet via a first electrical cord, convert the AC power to direct current (DC) power, and provide DC power to IHS 200 via a second electrical cord.

Additionally, or alternatively, AC adapter/PSU 215 may include an internal or external power supply portion (e.g., a switching power supply, etc.) connected to the second electrical cord and configured to convert AC to DC. AC adapter/PSU 215 may also supply a standby voltage, so that most of IHS 200 can be powered off after preparing for hibernation or shutdown, and powered back on by an event (e.g., remotely via wake-on-LAN, etc.). In general, AC adapter/PSU 215 may have any specific power rating, measured in volts or watts, and any suitable connectors.

IHS 200 may also include internal or external battery 216. Battery 216 may include, for example, a Lithium-ion or Li-ion rechargeable device capable of storing energy sufficient to power IHS 200 for an amount of time, depending upon the IHS's workloads, environmental conditions, etc. In some cases, a battery pack may also contain temperature sensors, voltage regulator circuits, voltage taps, and/or charge-state monitors. For example, battery 216 may include a current limiter, or the like.

In some embodiments, battery 216 may be configured to detect overcurrent or undervoltage conditions using Limits Management Hardware (LMH). As used herein, the term “overcurrent” refers to a condition in an electrical circuit that arises when a normal load current is exceeded (e.g., overloads, short circuits, etc.). Conversely, the term “undervoltage” refers to a condition (e.g., “brownout”) where the applied voltage drops to X % of rated voltage (e.g., 90%), or less, for a predetermined amount of time (e.g., 1 minute).

Power Management Unit (PMU) 212 governs power functions of IHS 200, including AC adapter/PSU 215 and battery 216. For example, PMU 212 may be configured to: monitor power connections and battery charges, charging batteries, control power to other components, devices, or ICs, shut down components when they are left idle, control sleep and power functions (On and Off), managing interfaces for built-in keypad and touchpads, regulate real-time clocks (RTCs), etc.

In some implementations, PMU 212 may include one or more Power Management Integrated Circuits (PMICs) configured to control the flow and direction or electrical power in IHS 200. Particularly, a PMIC may be configured to perform battery management, power source selection, voltage regulation, voltage supervision, undervoltage protection, power sequencing, and/or charging operations. It may also include a DC-to-DC converter to allow dynamic voltage scaling, or the like.

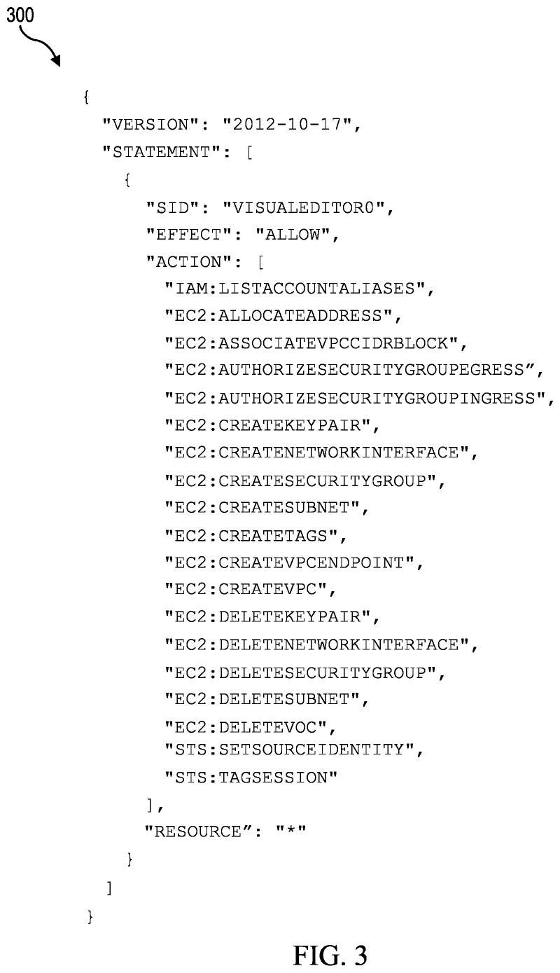

Additionally, or alternatively, PMU 212 may include a Battery Management Unit (BMU) (referred to collectively as “PMU/BMU 212”). AC adapter/PSU 215 may be removably coupled to a battery charge controller within PMU/BMU 212 to provide IHS 200 with a source of DC power from battery cells within battery 216 (e.g., a lithium ion (Li-ion) or nickel metal hydride (NiMH) battery pack including one or more rechargeable batteries). PMU/BMU 212 may include non-volatile memory and it may be configured to collect and store battery status, charging, and discharging information, and to provide that information to other IHS components, such as, for example devices within heterogeneous computing platform 300 (FIG. 3).

Examples of information collected and stored in a memory within PMU/BMU 212 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), and BMU events.

Examples of BMU events may include, but are not limited to acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, power draw measurements may be conducted with control and monitoring of power supply via PMU/BMU 212. Power draw data may also be monitored with respect to individual components or devices of IHS 200. Whenever applicable, PMU/BMU 212 may administer the execution of a power policy, or the like.

IHS 200 may also include one or more fans 217 configured to cool down one or more components or devices of IHS 200 disposed inside a chassis, case, or housing. Fan(s) 217 may include any fan inside, or attached to, IHS 200 and used for active cooling. Fan(s) 217 may be used to draw cooler air into the case from the outside, expel warm air from inside, and/or move air across a heat sink to cool a particular IHS component. In various embodiments, both axial and sometimes centrifugal (blower/squirrel-cage) fans may be used.

In other embodiments, IHS 200 may not include all the components shown in FIG. 2. In other embodiments, IHS 200 may include other components in addition to those that are shown in FIG. 2. Furthermore, some components that are represented as separate components in FIG. 2 may instead be integrated with other components, such that all or a portion of the operations executed by the illustrated components may instead be executed by the integrated component.

For example, in various embodiments described herein, host processor(s) 201 and/or other components of IHS 200 (e.g., chipset 202, display/touch controller(s) 204, communication interface(s) 205, EC/BMC 209, etc.) may be replaced by discrete devices within a heterogeneous computing platform. As such, IHS 200 may assume different form factors including, but not limited to: servers, workstations, desktops, laptops, appliances, video game consoles, tablets, smartphones, etc.

Best practice for granting third party access entails defining a role with a set of permissions that the third party is trusted within an account 126. In the present case, the customer grants a third-party entity (e.g., an AWS entity) certain trusted access in which no credentials are exchanged. The third-party entity owns the necessary credentials to gain access to the customer's account and is responsible for managing them, which eliminates the need for both parties to act to carry out a credential change. The customer maintains the ability to disable third-party access at any time.

Many cloud computing platforms, such as AWS, provide options to trust different entities to assume a role. The design is to use an entity, such as an AWS Identity and Access Management (IAM) user, as a principal in the trust policy. With a single AWS IAM user dedicated to each customer, the system can be scaled to support a relatively large quantity (e.g., 5000 customers) under a single AWS account. Multiple AWS accounts would be used to scale beyond 5000 customers. No two customers trust the same AWS IAM user. Each AWS IAM user is tagged with an identifier for the customer to identify the IAM user resource as belonging to the customer. The IAM user credentials, AWS account IDs, AWS Role AWS Resource Name (ARN), and external ID used in the AWS assume role API call are stored in the secure storage 118 and are used to obtain temporary credentials passed to computing resource management tool 120 for authorized access to the customer's AWS account resources 104.

Regarding conventional attempts where keys are shared between the customer and computing resource vendor as described herein above, if the third-party entity (e.g., vendor) found it mishandled the customer's credentials internally, and there was potentially unintended access to that customer environment, then the way to remedy that access would be to rotate or disable the credentials, which is managed and owned by the customer. The time to resolve such a scenario would depend on identifying the issue, being able to reach the customer, and then tracking down, by the customer, the right person to disable or rotate the credentials. Such action to remedy potentially leaked credentials would likely impact the trusted relationship with that customer. This third-party trusted access system 100 mitigates this problem and allows either the customer or Dell to act to alleviate the issue.

There is also the concern of ownership with leaked credentials. Consider the scenario where the customer were to provide an access key; however, the customer also accidentally leaked the access key and this led to malicious activity in the customer's account. In this scenario it would be difficult to identify ownership of who leaked the credential. The customer could blame the third-party entity (e.g., computing resource vendor) when it was actually the customer. The third-party trusted access system 100 provides clear ownership of the access credentials. Regarding credential rotation, If the customer owns the credentials, then they also own credential rotation. Rotation is inherently out of any third-party entity's control, and that rotation will render the customer's environment inaccessible between rotation and re-distributing to the third-party entity. The third-party trusted access system 100 provides responsibility of rotation to the third-party entity, and it can maintain access throughout rotation. In summary, the third-party trusted access system 100 provides the ability to manage trusted access from services running outside of the cloud computing platform 102 to numerous (e.g., thousands) of customer accounts at scale by leveraging automation and various technologies.

FIG. 3 illustrates an example permissions document 300 that may comprise a portion of the access control policy key 112 according to one embodiment of the present disclosure. The permissions document 300 is a JSON document defining certain limited actions that may be performed by the computing resource management tool 120. In one aspect, the permissions document 300 may be considered to be a whitelist in which only the actions specified in the permissions document 300 are permitted to be performed by the computing resource management tool 120; all other actions are prohibited. In one embodiment, the permissions document 300 follows the IAM policy standard established by AWS. In another embodiment, entries in the permissions document 300 may be added, modified, or deleted at any time by the customer. Thus, the customer may change third-party access policies at an ongoing basis to adjust for ongoing changes, such as changes in security context, organizational structure, and the like.

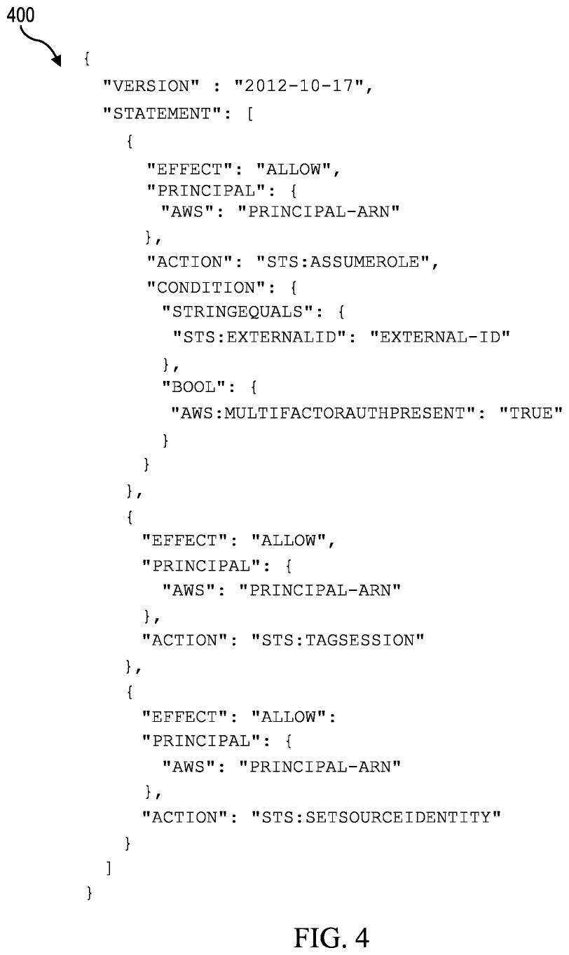

FIG. 4 illustrates an example trust policy document 400 that may comprise a portion of the access control policy key 112 according to one embodiment of the present disclosure. The trust policy document 400 is a JSON document specifying the trusted principals to assume a role (e.g., an AWS role). In the present example trust policy document 400, the ‘Principal ARN’ (e.g., AWS Resource Name) is the unique identifier to the trusted IAM entity. Additionally as can be seen, the trust policy document 400 condition ‘AWS: MultiFactorAuthPresent’ requires all requests to have been authenticated with Multi-Factor Authentication (MFA).

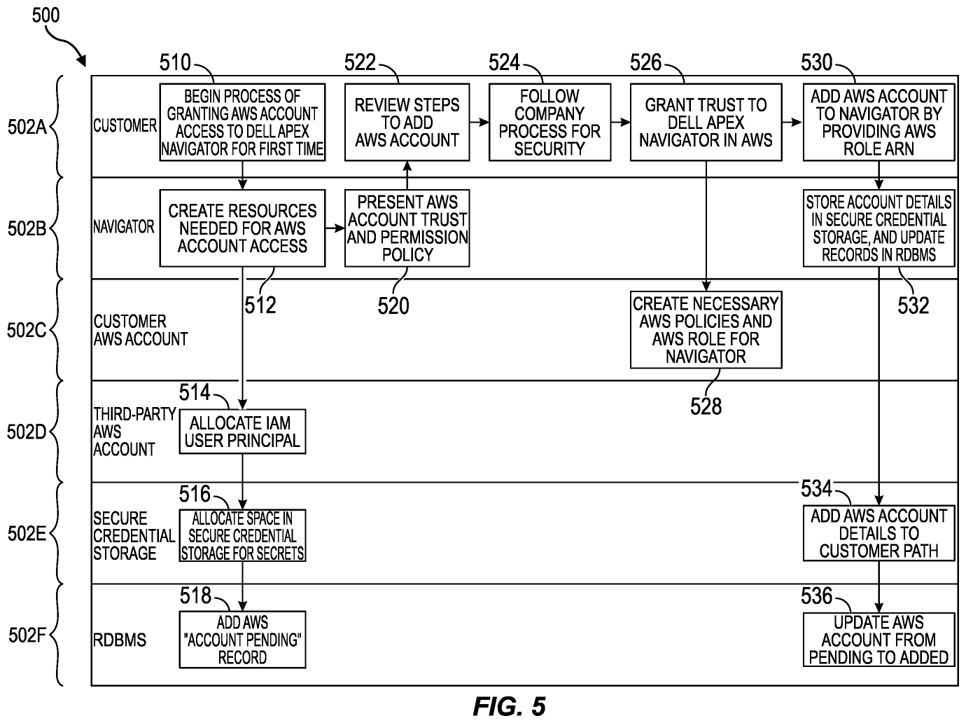

FIG. 5 illustrates an example third-party trusted access method 500 that may be performed by the third-party trusted access system 100 to grant cloud platform access to the computing resource management tool 120 according to one embodiment of the present disclosure. The method 500 may be performed at any time. In one embodiment, the method 500 may be performed each time a customer establishes certain limited access rights to the computing resources 104 leased from the cloud computing platform 102 for the first time. Additionally or alternatively, the third-party trusted access method 500 may be performed at least in part, by the third-party trusted access system 100 as described herein above with reference to FIG. 1.

The third-party trusted access method 500 is shown in rows 502a-f (collectively 502) in which the steps in row 502a are those that may be performed by the customer, row 502b are those steps that may be performed by the computing resource management tool 120, row 502c are those steps that may be performed by the customer from within their account 126, row 502d are those steps that may be performed by the third-party AWS organization 108, row 502e are those steps that may be performed by the secure storage 118, while row 502f are those steps that may be performed by the cloud computing platform 102.

Initially at step 510, the customer begins the process of granting its customer account 114 access to the computing resource management tool 120 for the first time. For example, the computing resource management tool 120 may present an interactive GUI to the customer that allows them to select granting access to their customer account 114. Upon receiving this request, the computing resource management tool 120 creates the resources needed for account access at step 512 in which the created resources may include, among other things, an access control policy key 112 (e.g., AWS IAM key) that is allocated within the third-party AWS organization 108 at step 514, allocated space in the secure storage 118 at step 516, and an account ‘pending’ record in the cloud computing platform 102 at step 518.

The computing resource management tool 120 also presents the default account trust and permission policies for review by the customer at step 520. The default account trust policies may be, for example, those policies shown in the JSON document of FIG. 4, while the permission policies may be those policies shown in the JSON document of FIG. 3. At step 522, the customer reviews the default account trust and permission policies, and at step 524, makes any desired changes to the default account trust and permission policies, such as those changes to follow the company's established processes for security.

At step 526, the customer grants trust to the computing resource management tool 120, and using their customer account 114, creates the policies and roles for the computing resource management tool 120 at step 528. The customer also adds their customer account 114 to the computing resource management tool 120 by providing a role AWS Resource Name (ARN) to the computing resource management tool 120 at step 530. The computing resource management tool 120 stores the account details in the secure storage 118 and updates the associated records in the cloud computing platform 102 at step 532. The computing resource management tool 120 also adds account details in the secure storage 118 at step 534, and updates the cloud computing platform account from ‘pending’ to ‘added’ at step 536. At this point, the computing resource management tool 120 may use the access control policy key 112 to access the computing resources 104 using the account trust and permission policies established for that account.

The steps of the aforedescribed process may be performed each time a customer is to grant limited access to its computing resources 104 to a third-party (e.g., the vendor of those computing resources 104). Nevertheless, when use of the third-party trusted access method 500 is no longer needed or desired, the process ends.

Although FIG. 5 describes an example method 500 that may be performed to grant limited access to its computing resources 104 to the vendor of those computing resources 104, the features of the method 500 may be embodied in other specific forms without deviating from the spirit and scope of the present disclosure. For example, the method 500 may perform additional, fewer, or different operations than those described in the present examples. For another example, the method 500 may be performed in a sequence of steps different from that described above. As yet another example, certain steps of the method 500 may be performed by other components than those described above.

When a vendor's products are deployed to the cloud by the computing resource management tool 120, a software management layer, such as a software defined storage service (e.g., DELL POWERFLEX) may run on top of the infrastructure layer (e.g., AWS compute, storage, networking, etc.), but it is often difficult for customers to understand the complex relationships between the two layers. That is, it may be difficult from a computing resource management tool's viewpoint to correlate computing resources from the cloud computing platform's viewpoint. This problem is further exacerbated by the fact that the cloud computing platform can potentially comprise large numbers of resources, and thus referencing one computing resource in a cloud computing platform's GUI with that of the computing resource management tool 120 can be a difficult endeavor.

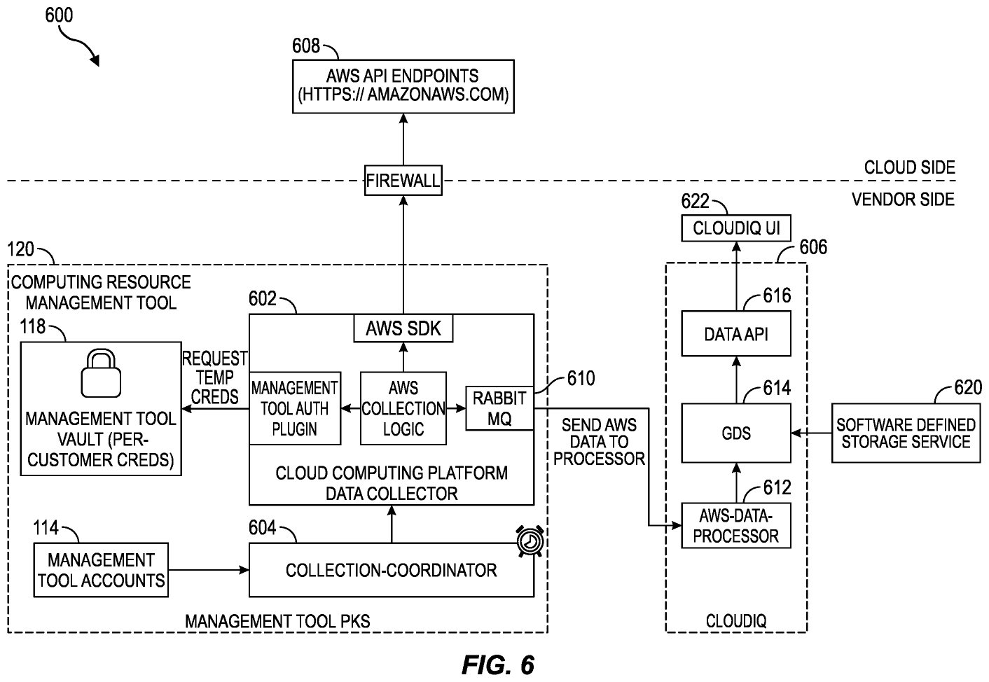

FIG. 6 illustrates an example computing resource correlation system 600 showing how the computing resource management tool 120 may be used to correlate the computing resources it manages with that of a cloud computing platform according to one embodiment of the present disclosure. The computing resource management tool 120 includes a cloud computing platform data collector 602 in communication with the secure storage 118, a collection coordinator 604, a cloud monitoring tool 606, and a cloud computing platform REST API 608 as shown. In one embodiment, the computing resource management tool 120 may comprise at least a portion of an APEX NAVIGATOR cloud management tool, while the cloud monitoring tool 606 may comprise at least a portion of a CLOUDIQ cloud monitoring tool, which are both provided by DELL TECHNOLOGIES. Additionally, the REST API 608 may include any suitable user interface for managing the operation of one or more computing resources 104 configured in the cloud computing platform 102. In a particular case where the cloud computing platform is AWS, the data collector 602 accesses the REST API 608 to collect details from the cloud computing platform 102.

Generally speaking, the data collector 602 gathers information over time about computing resources 104 that are being addressed by the REST API 608, and sends the gathered information to the cloud monitoring tool 606 to be correlated with information the data collector 602 knows about the computing resources 104 that are being addressed. The computing resource management tool 120 possesses certain limited access rights to each of the customers leased computing resources 104 via the customer accounts 114 and access control policy key 112 as described above with reference to FIGS. 1-5. In one embodiment, the data collector 602 may issue requests to the REST API 608 that causes the cloud computing platform 102 to respond to relevant information about the computing resources 104 for each customer account 114 in the cloud computing platform 102. For example, the data collector 602 may poll the REST API 608 at ongoing (e.g., periodic) intervals so that the correlated information seen by the user is continually updated. In another embodiment, when the REST API 608 establishes a login session using the access control policy key 112 to manage the operation of certain computing resources 104 for a customer, the data collector 602 may function at least somewhat like a sniffer to collect certain parametric data obtained from the computing resources 104 so that the obtained parametric data may be correlated with data about those computing resources 104 as maintained by the computing resource management tool 120 using certain criteria. Details about the nature and type of criteria that may be used will be described in detail herein below. The collection coordinator 604 associates the data obtained from the computing resources 104 with each customer account 114 maintained in the system.

The obtained data may be sent to the cloud monitoring tool 606 using a RABBITMQ message broker 610 or any other suitable inter-application message broker. The cloud monitoring tool 606 includes a cloud computing platform data processor 612 that uses one or more types of criteria to correlate computing resources 104 from the REST API 608 to that of the computing resource management tool 120, a Generic Data Store 614, and a data API 616 that exposes the correlated data for consumption by the computing resource management tool 120 as will be described in greater detail herein below.

The computing resource management tool 120 collects a limited set of cloud platform telemetry data on a regular basis from each customer account 114 where the computing resource management tool 120 has deployed software, while the cloud monitoring tool 606 correlates the AWS telemetry stream with deployment records (e.g., what computing resources were deployed to each customer account 114) and the telemetry stream from the computing resource management tool 120. This correlation leverages key properties of the data such as virtual network (e.g., Virtual Private Cloud (VPC)) IDs and IP addresses. The mechanism of correlation can be implemented as database joins, code logic, or a combination of the two.

The GDS 614 may collect and store information, such as deployment details and resource mapping of computing resources, from the computing resource management tool 120, such as via HTTP POST commands issued from the computing resource management tool 120 to the GDS 614. The GDS 614 may also collect and store information from other computing resource management tools, such as a software-defined storage service 620 (e.g., POWERFLEX). The data processor 612 may use information obtained from the computing resource management tool 120 and software-defined storage service 620 to correlate information known about the computing resources 104 through the cloud computing platform 102.

Data available to the data processor 612 via the computing resource management tool 120 may include cloud platform accounts (AWS accounts), cloud platform regions (cloud platform regions), cloud platform Virtual Private Clouds (VPCs) where the systems are deployed. Data available to the data processor 612 via the message broker 610 may include VPC data and AWS Elastic Compute Cloud (EC2) data. Additionally, data available to the data processor 612 via the storage data servers 620 may include system and sub-component details.

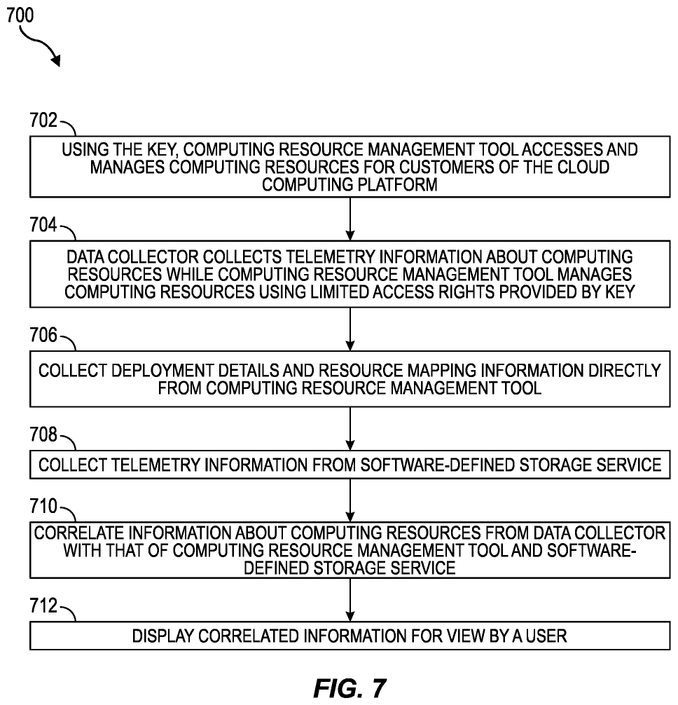

FIG. 7 illustrates an example computing resource correlation method 700 that may be performed by the computing resource correlation system 600 to correlate information about computing resources across different applications that manage those computing resources according to one embodiment of the present disclosure. The method 700 may be performed continually as the cloud computing platform 102, computing resource management tool 120, cloud monitoring tools 606, and 620 are being used so that computing resources 104 may be continually correlated with one another across the different application domains.

Initially at step 702, computing resource management tool 120 accesses and manages computing resources for customer accounts 114 of cloud computing platform using the access control policy key 112. For example, the customer accounts 114 may be those whose computing resources have been granted computing resource access to the computing resource management tool 120 as described above with reference to the method of FIG. 5. At step 704, the data collector 602 collects telemetry information about computing resources while computing resource management tool 120 manages computing resources using limited access rights provided by access control policy key 112. The data collector 602 may then store the collected telemetry information in the GDS 614. In one embodiment, the data collector 602 may obtain the telemetry information from a cloud computing platform (e.g., AWS endpoint) used to manage computing resources. At step 706, the GDS 614 stores deployment details and resource mapping information directly from computing resource management tool 120. The GDS 614 also stores telemetry information from the storage data server service 620 (e.g., POWERFLEX).

At step 708, the data processor 612 collects telemetry information. Given the telemetry information provided, the data processor 612 correlates information about computing resources from data collector 602 with that of computing resource management tool 120 and storage data server 620 at step 710. If the computing resources 104 are to be correlated with a storage data server system (e.g., POWERFLEX System), the data collector 602 may first find computing resources 104 (e.g., AWS EC2s) in the same customer account 114 and/or VPC as the storage data server system, and keep only those computing resources 104 instances with IP addresses that match the IP addresses used by the storage data server system Storage Data Servers (SDSs). That is, the computing resources 104 may be correlated using their IP addresses because the IP addresses are unique within a VPC. If the computing resources 104 are to be correlated with a SDS protection domain (e.g., POWERFLEX Protection Domain), the data collector 602 may first find the specific SDS number (n) corresponding to the EC2 instance (m), and from the SDS number, the corresponding protection domain can be identified. To provide additional correlation, once key cloud platform (e.g., AWS) computing resources 104 can be mapped to storage data server 620 (e.g., PowerFlex) computing resources 104 as shown above, additional relationships can be inferred. For example, AWS EC2 instances can be correlated with PowerFlex pools since it is known which pools exist within a Protection Domain.

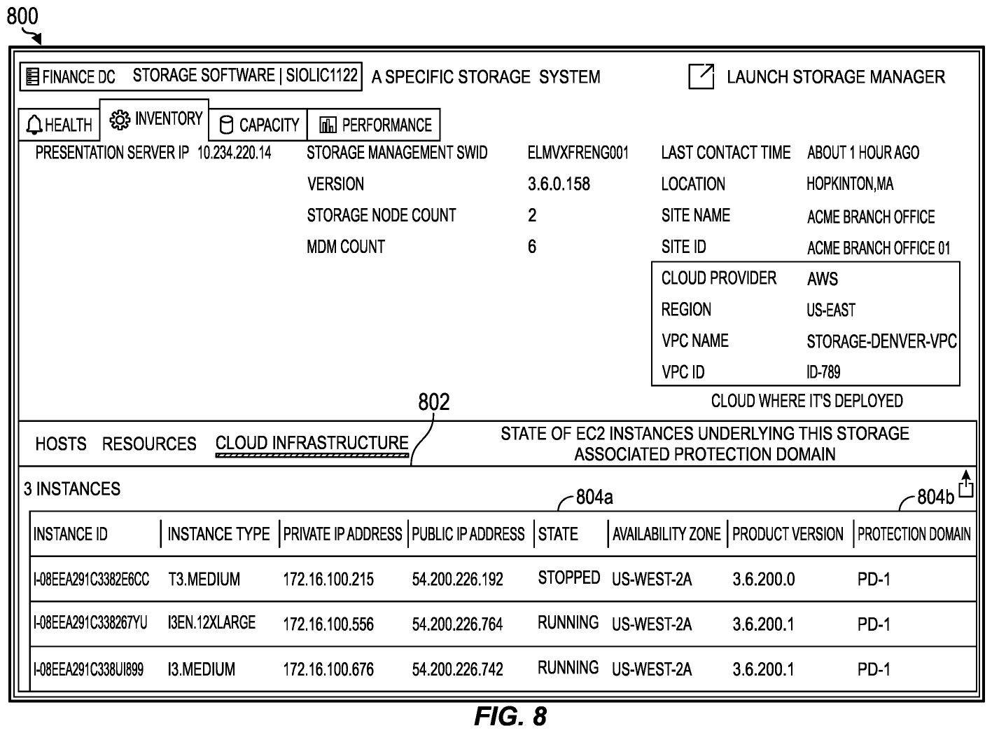

Thereafter at step 712, the correlated computing resources information can be displayed for view by a user. FIG. 8, for example, shows how the system 600 may be used to display correlated computing resource information and will be described in detail herein below. The steps of the aforedescribed process may be performed each time a customer is to grant limited access to its computing resources 104 to the vendor of those computing resources 104. Nevertheless, when use of the computing resource correlation method 700 is no longer needed or desired, the process ends.

Although FIG. 7 describes an example method 700 that may be performed to grant limited access to its computing resources 104 to the vendor of those computing resources 104, the features of the method 700 may be embodied in other specific forms without deviating from the spirit and scope of the present disclosure. For example, the method 700 may perform additional, fewer, or different operations than those described in the present examples. For another example, the method 700 may be performed in a sequence of steps different from that described above. As yet another example, certain steps of the method 700 may be performed by other components than those described above.

FIG. 8 illustrates an example GUI 800 that may be displayed by the cloud monitoring tool 606 according to one embodiment of the present disclosure. In particular, the cloud monitoring tool 606 may be a CLOUDIQ monitoring tool showing how the features of the present disclosure may be used to troubleshoot infrastructure issues (e.g., a stopped EC2 instance) and understand its impact on the SDS system.

As shown, a table 802 is included with each row corresponding to a computing resource 104 in the cloud computing platform 102. The table 800 includes several columns in which one column 804a indicates an operational state of its associated computing resource 104, while another column 804b indicates a protection domain that its associated computing resource 104 is arranged in. Without the computing resource correlation system 600, users would often have to go to separate portals (e.g., vendor-side and AWS-side) to see this level of detail for their vendor products and associated cloud infrastructure, and they would have to manually correlate the disjointed data. Embodiments of the present disclosure provide a solution to this problem among other by providing users with a combined view (as well as proactive monitoring) of the software and infrastructure layers via the cloud monitoring tool 606 (e.g., CloudIQ) and/or computing resource management tool 120 (e.g., APEX Navigator). Individual cloud platform components can be viewed in the context of the associated vendor product or sub-component of that product. For example, an individual AWS EC2 instance can be viewed in the context of the PowerFlex using that EC2 instance, and even associated with a specific PowerFlex Protection Domain. This helps customers understand the relationships and impacts of the cloud infrastructure on their vendor software and associated applications in some embodiments.

In accordance with the foregoing, embodiments of the present systems and methods provide secure temporary privileged access to nodes in a cluster. To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). This may include selecting predefined logic blocks and logically associating them. It may also include programming computer software-based logic of a retrofit control device, wiring discrete hardware components, or a combination thereof. Such configured devices are physically designed to perform the specified operation(s).

Various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An Information Handling System (IHS) comprising:
a cloud computing platform comprising a plurality of computing resources; and
at least one memory coupled to at least one processor, the at least one memory having program instructions stored thereon that, upon execution by the at least one processor, cause the instructions to:
receive, from a customer, a request to grant to a computing resource management tool limited access to at least a portion of the computing resources, the computing resource management tool managed by a vendor of the computing resources;
generate an access control policy key in response to the request, the key comprising one or more policies associated with how the computing resource management tool is allowed to access the portion of computing resources;
provide the key to the computing resource management tool; and
access, by the computing resource management tool, the portion of computing resources according to the policies included in the key.

2. The IHS of claim 1, wherein the program instructions, upon execution, further cause IHS to:
receive, from the customer, user input for modifying the policies associated with the access control policy key; and
access, by the computing resource management tool, the portion of the computing resources according to the modified policies.

3. The IHS of claim 1, wherein the policies comprise at least one of access policies and trust policies.

4. The IHS of claim 1, wherein the key comprises an Amazon Web Services (AWS) IAM key.

5. The IHS of claim 1, wherein the program instructions, upon execution, further cause IHS to store the key in a secure vault.

6. The IHS of claim 1, wherein the program instructions, upon execution, further cause IHS to generate the key using a third-party account in the cloud computing platform, the third-party account managed by the vendor of the computing resources.

7. The IHS of claim 1, wherein the program instructions, upon execution, further cause IHS to:
obtain, using the key, telemetry information associated with the portion of the computing resources;
correlate the obtained telemetry information with third-party information of a computing resource management service; and
display the correlated information for view by a user.

8. The IHS of claim 7, wherein the program instructions, upon execution, further cause IHS to obtain the telemetry information from an API endpoint of the cloud computing platform.

9. The IHS of claim 7, wherein the program instructions, upon execution, further cause IHS to correlate the obtained telemetry information with the third-party information using Internet Protocol (IP) addresses of the computing resources.

10. The IHS of claim 1, wherein the computing resource management service comprises a storage data server service managed by the third-party.

11. A third-party trusted access method comprising:
receiving, from a customer, a request to grant to a computing resource management tool limited access to at least a portion of a plurality of computing resources of a cloud computing platform, the computing resource management tool managed by a vendor of the computing resources;
generating an access control policy key in response to the request, the key comprising one or more policies associated with how the computing resource management tool is allowed to access the portion of computing resources;
providing the key to the computing resource management tool; and
accessing, by the computing resource management tool, the portion of computing resources according to the policies included in the key.

12. The third-party trusted access method of claim 11, further comprising:
receiving, from the customer, user input for modifying the policies associated with the access control policy key; and
accessing, by the computing resource management tool, the portion of the computing resources according to the modified policies.

13. The third-party trusted access method of claim 11, further comprising storing the key in a secure vault.

14. The third-party trusted access method of claim 11, further comprising generating the key using a third-party account in the cloud computing platform, the third-party account managed by the vendor of the computing resources.

15. The third-party trusted access method of claim 11, further comprising:
obtaining, using the key, telemetry information associated with the portion of the computing resources;
correlating the obtained telemetry information with third-party information of a computing resource management service; and
displaying the correlated information for view by a user.

16. The third-party trusted access method of claim 15, further comprising obtaining the telemetry information from an API endpoint of the cloud computing platform.

17. The third-party trusted access method of claim 15, further comprising correlating the obtained telemetry information with the third-party information using Internet Protocol (IP) addresses of the computing resources.

18. A computer program product comprising a computer readable storage medium having program instructions stored thereon that, upon execution by an Information Handling System (IHS), cause the IHS to:
receive, from a customer, a request to grant to a computing resource management tool limited access to at least a portion of a plurality of computing resources of a cloud computing platform, the computing resource management tool managed by a vendor of the computing resources;
generate an access control policy key in response to the request, the key comprising one or more policies associated with how the computing resource management tool is allowed to access the portion of computing resources;
provide the key to the computing resource management tool; and
access, by the computing resource management tool, the portion of computing resources according to the policies included in the key.

19. The computer program product of claim 18, wherein the program instructions, upon execution, further cause IHS to:
receive, from the customer, user input for modifying the policies associated with the access control policy key; and
access, by the computing resource management tool, the portion of the computing resources according to the modified policies.

20. The computer program product of claim 18, wherein the program instructions, upon execution, further cause IHS to:
obtain, using the key, telemetry information associated with the portion of the computing resources;
correlate the obtained telemetry information with third-party information of a computing resource management service; and
display the correlated information for view by a user.
